(19) United States
(12) Patent Application Publication
(10) Pub. No.: US 2009/0228949 A1
(43) Pub. Date: Sep. 10, 2009

(54) DIGITAL BROADCASTING TERMINAL

(75) Inventors: Immo Benjes, Redhill (GB); Jonathan C. Foster, Bradford-On-Avon (GB); Richard J. Houldsworth, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/597,382

(22) PCT Filed: Jan. 27, 2005
(86) PCT No.: PCT/IB2005/050345

§ 371 Date: Jul. 24, 2006

(30) Foreign Application Priority Data
Jan. 28, 2004 (GB) 0401781.0

(51) Int. Cl. H04N 7/16; G06F 9/45

(52) U.S. Cl. 725/152; 717/140; 717/139; 717/136

(57) ABSTRACT

A terminal (60) in a digital broadcasting system supports a virtual machine (150), such as a Java™ virtual machine, which processes applications in a first code format, such as Java™ byte code. A plug-in (110) is provided which converts applications that are received in a second code format into the first code format. The plug-in (110) can compile (120) the application into the first code format. The application can be compiled (120) upon receipt, or it may be stored (69) and compiled at a later time, such as overnight or when the virtual machine (150) has spare processing capacity (114). Applications can be converted based on monitored usage statistics (112).

This invention relates to digital broadcasting terminals and, in particular, to processing applications in such terminals.

Digital Video Broadcasting (DVB) systems were originally developed to deliver audio and video material. In recent years there has been increasing interest in delivering applications that can be downloaded and executed by terminals. The Digital Video Broadcasting Multimedia Home Platform (DVB-MHP) is a result of efforts to harmonise standards for multimedia set top boxes. It is an open, published, standard for interactive digital television. DVB-MHP, or simply MHP, defines a generic interface between interactive digital applications and the terminals that execute those applications. MHP standards, such as ETSI TS 101 812 V1.3.1, can be viewed at www.etsi.org. Version 1.0.3 of the MHP standard supports freely downloadable applications called ‘Xlets’. Digital Video Broadcasting Globally Executable MHP (DVB-GEM), set out in ETSI TS 102 819, also supports downloadable applications. However, the MHP cannot directly process applications in any other format, such as MHEG-5. The MHP supports ‘plug-ins’ for handling application formats other than those defined in the standard, which are activated when relevant data is received by the terminal. The defined output of a plug-in is simply the execution of the application.

In markets where standards other than the MHP are used for interactive TV (e.g. in the UK where MHEG is used) it is desirable to have MHP terminals that support the legacy systems. It is possible to convert from the legacy format to MHP on the broadcast side of the transmission chain, but this has some disadvantages. In particular, it may require content to be simulcast in both the legacy and new formats, which is wasteful of bandwidth.

Plug-ins for MHP terminals can be used to interpret legacy application formats but interpreting descriptive languages such as MHEG can be slow.

The present invention seeks to provide a digital broadcast terminal that can process alternative formats.

Accordingly, a first aspect of the present invention provides a method of processing an application at a terminal in a digital broadcasting system, the terminal supporting a virtual machine which is arranged to process applications in a first code format, the method comprising the steps of: the method of any one

receiving an application in a second code format; and

converting at least part of the application into the first code format.

Converting applications written in the second code format, such as a descriptive language, to the first code format supported by the virtual machine can improve the execution speed of the terminal, especially when the code is executed several times. It will be appreciated that the terminal will also have a native code format underlying the virtual machine which will be particular to the hardware and software of that terminal. It is preferred that the step of converting the application compiles at least part of the application into the first code format.

Complete conversion of the application to the first code format allows the converted application to be used independently of a plug-in. This is useful if the application is being stored or propagated to other devices.

For an MHP terminal, the virtual machine is a Java™ virtual machine and the first code format is Java bytecode. Applications may be received in a legacy format such as MHEG-5. For a single rendering of a page of information, the overall time taken to compile code from a second code format into the first code format is likely to be greater than Interpreting the code. However, once compiled into the first format, execution of the code is significantly faster. Thus, if the page is to be used on multiple occasions, considerable time savings are possible compared to interpreting the code on multiple occasions. If the Java Virtual Machine has a JIT (Just In Time) compiler then the Java bytecode can be further compiled from Java bytecode into the native code of the terminal, thereby improving the execution speed even further.

Once converted to the first format, such as an executable MHP Xlet, the content may be stored and reused in devices that support MHP. For example, recording of a service containing a legacy interactive application could be done by converting the application to MHP and then saving this application on the storage device. The playback device to which the application is sent only needs to support MHP and does not need to have a plug-in supporting the legacy application type.

A further advantage of compiling the content is that the footprint, in terms of class size and runtime memory usage, of the compiled application will usually be less than that of an interpreter, because the interpreter needs be able to process the complete language feature set rather than only those parts that are used by the application. The method is not limited to conversion of content in the MHEG-5 format, and can be used to convert content from other legacy application formats such as OpenTV or MediaHighway.

Preferably, the method is performed by a software plug-in which can be supplied with the terminal, or downloaded to the terminal at some later time as an upgrade. Accordingly, another aspect of the invention provides software for performing the method. The software may be stored on an electronic memory device, hard disk, optical disk or other machine-readable storage medium. The software may be delivered as a computer program product on a machine-readable carrier or it may be downloaded directly to the terminal via a broadcast channel or a network connection.

Further aspects of the invention provide a control apparatus for a terminal which performs this method, and a terminal incorporating the control apparatus or software. The terminal is most likely to take the form of a set-top box (STB) but it can take other forms, such as a multimedia personal computer (PC) or a television set which incorporates the functionality of the set-top box.

Embodiments of the present invention will now be described, by way of example only, with reference to the accompanying drawings, in which:

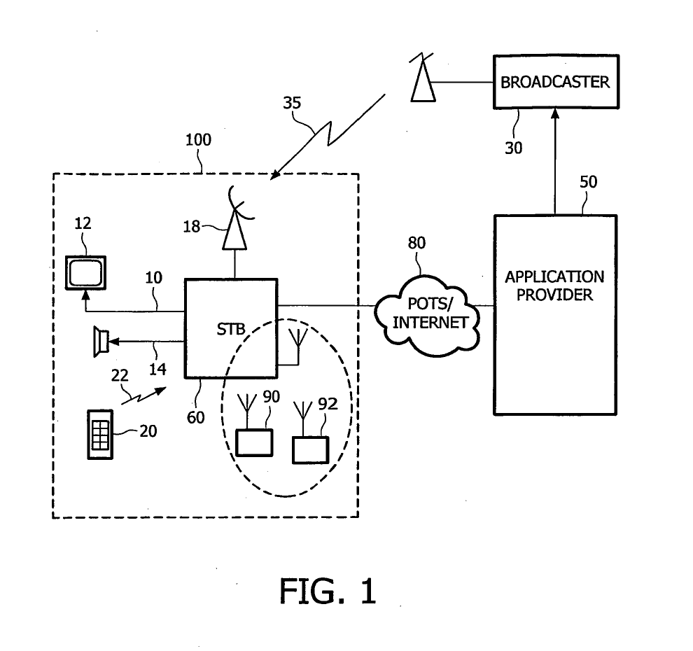

FIG. 1 shows a digital broadcasting system;

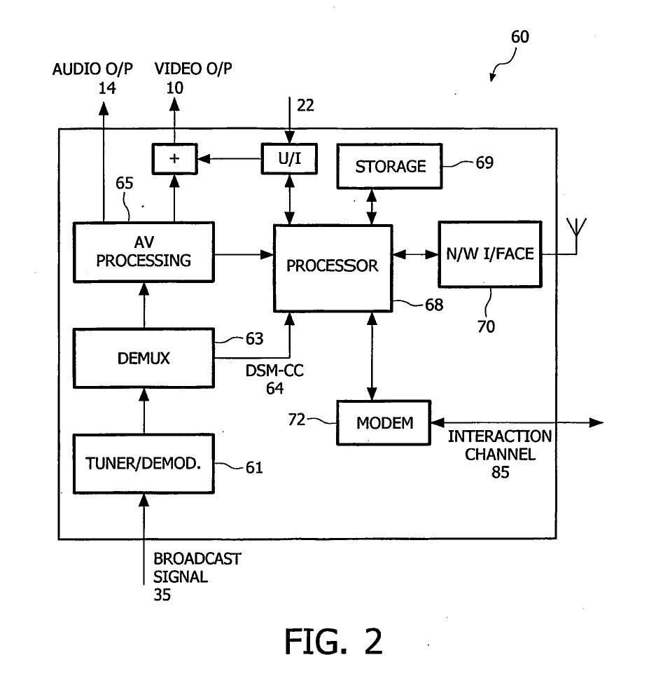

FIG. 2 shows the subscriber terminal of FIG. 1;

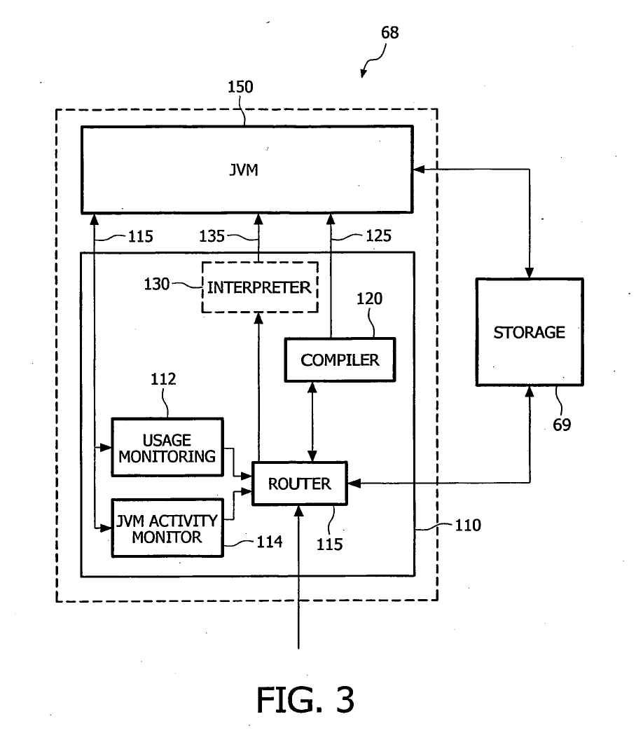

FIG. 3 shows the main functional blocks of the processing environment used by the terminal of FIG. 2, to perform an embodiment of the invention.

FIG. 1 shows a digital video broadcasting system for delivering applications to a terminal. Content is generated by a broadcaster 30 and converted into a suitable format for transmission, via a broadcast channel 35, to user premises 100. One such premises 100 is shown. Typically, the broadcast channel 35 is delivered via a satellite although it can be delivered by a terrestrial transmission network, a cable distribution network, or a data network such as the Internet, and the method of delivery is not important to the invention. A terminal (set-top box, STB) 60 at a user premises receives the broadcast stream, which in this embodiment is via an antenna 18. The broadcast stream delivered via the broadcast channel 35 comprises audio and video content as well as data for supporting various services and applications. In the DVB-MHP specification, data for applications is broadcast as part of a Digital Storage Media—Command and Control (DSM-CC) Object Carousel. This is a repetitively broadcast file system containing the data files for various applications. The format of the broadcast channel for the DVB-MHP system, including the DSM-CC, is set out In ISO/IEC 13818-6, to which the skilled reader is directed for further information.

Applications can be created by the broadcaster 30 or by independent application providers 50 who supply the required files to the broadcaster 30 for insertion in the DSM-CC. Examples of applications include electronic programme guides (EPG), games, quizzes, instructional guides and e-commerce applications such as home banking.

The set top box 60 is also provided with a modem to support an interaction channel 85 to allow the set top box 60 to send data to, and receive data from, external parties. The interaction channel 85 typically uses a conventional telephony network such as POTS. The interaction channel 85 can take the form of: a dial-up connection directly over POTS to an application provider 50, a connection to a gateway of a data network such as the internet, with the connection between the gateway and the application provider 50 being carried across the data network, a combination of a cable back-channel and a connection across a data network (internet) to the application provider, an ADSL or other broadband internet connection, satellite uplink or ISDN line.

Set-top box 60 also includes a user interface with a remote control 20 or keyboard for receiving user inputs 22 and a graphical output for displaying messages which can be overlaid upon the video signal 10 which is fed to lo television display 12.

FIG. 2 shows the functional blocks within a typical MHP terminal 60. In a known manner, terminal 60 includes a front end for processing a received broadcast signal 35. This includes a tuner and demodulator 61 for selecting and demodulating a required channel and an optional conditional access unit 62 for descrambling the signal. The resulting digital data stream is demultiplexed 63 into data streams representing audio and video data (typically in MPEG-2 format) and data for applications in the form of the repetitively broadcast DSM-CC Object Carousel 64. The audio and video data can then be further processed 65 to derive suitable output signals 10, 14 for presentation to a user. Once downloaded from the broadcast stream, the application (or several applications) will reside on memory 69 in the terminal and will be executed by microprocessor 68. An application may receive user inputs 22, generate audio and video outputs, and access the interaction channel 85 via an Application Programming interface (API). Control software for operating the terminal also resides on storage 69. It should be noted that FIG. 2 shows a terminal which is intended to receive signals via a broadcast delivery channel. In other embodiments of the terminal, which are intended to interface with non-broadcast delivery channels, the tuner/demodulator 61 is replaced by a network interface appropriate to the delivery channel. This can be an Internet Protocol (IP)based delivery channel.

FIG. 3 shows the main parts of the processing environment, implemented by processor 68, which are relevant to the invention. An MHP terminal is built around a Java™ Virtual Machine (JVM) and applications are written in the Java language and then compiled into Java bytecode. The use of Java has the advantage that applications can be written in a common format, independent of the particular hardware and software resident on the terminal. An MHP application 110 which is resident on the terminal 60, or which is downloaded to the terminal, acts as a plug-in for certain content types (e.g. MHEG-5) which are not written in Java bytecode. This allows the terminal to display the content. MHEG-5 pages are received and routed 115 to a compiling function 120. The output 125 of the compiling function 120 is lo Java bytecode which can be executed by the JVM. The compiled Java bytecode can also be routed 115 to storage 69 in the terminal for later use.

To avoid large delays at application start-up, initially the application can be interpreted in a conventional manner, and then compiled to Java bytecode at a later point. Compilation of the code can be scheduled for a time at which the JVM is idle, or at least has sufficient spare processing capacity to perform the function, as determined by a JVM activity monitor 114. Alternatively, the compilation can be performed at a time which is known to be quiet, such as overnight. Thus, MHEG-5 content is received by the terminal, stored in storage 69, and then later retrieved from storage 69 and compiled into bytecode.

The decision of whether to compile the code can be based on usage statistics, such as frequency of use, or other heuristics, which are collected by a usage monitoring function 112. It will be appreciated that if a particular block of code is frequently used, there is an advantage in compiling it to Java bytecode. Usage monitoring function 112 can use a threshold to identify candidate blocks of code for compilation. The usage monitoring function and activity monitor 114 communicate with the JVM via an interface 115. Every MHP terminal has some kind of Application Database for MHP applications (a class defined in the MHP). This can be extended to, for example, monitor the use of different MHP (and non-MHP) applications. The data can be stored in non-volatile memory 69.

It is possible for the plug-in 110 to operate in a hybrid mode, where only parts of the received application are compiled 120 and the remainder of the application is processed in an interpreted manner 130. For example, the MHEG-5 format consists of declarative descriptions of a display layout, with scripting elements occurring on runtime events. A simple MHEG-5 compiler may choose to compile 120 only the sequences of scripted actions to new bytecode, and process the scene descriptions via an interpreter 130. This will produce most of the runtime speed improvements.

Referring again to FIG. 2, the terminal 60 has a network interface 70 lo which allows it to form part of a network of equipment at the premises 100. The home network 70 is shown here as a wireless network, such as wireless Ethernet (IEEE 802.11). However, this is not important to the invention and the network could be a wired network supporting a protocol such as Ethernet, power line networking (e.g. HomePlug), phone line networking (e.g. HomePNA) or a wireless network such as IEEE 802.11a, Bluetooth or ZigBee. Using the network interface 70, the terminal 60 can send compiled applications to other devices 90, 92 in the network. The other devices 90, 92 can be devices which lack the plug-in 110 to support legacy format types.

If direct creation of a ClassLoader by the plug-in is prevented, as in the current MHP specifications, then dynamically created Java classes can be loaded using a org.dvb.lang.DvbClassLoader instance which accesses a local server provided by the plug-in, as described in co-pending application GB 0318198.9. The plug-in application 110 creates an instance of the class representing the main MHEG-5 page and calls it's entry methods. The class can implement the normal Xlet interface and behave as a normal MHP application. The class created can follow the standard MHP rules, i.e. the main class of the application implements the javax.tv.xlet Interface and will behave like a normal MHP application (lifecycle etc.) or it can behave like a proprietary Java application.

In order to overcome the restriction on creating a ClassLoader, plug-in 110 creates a small HTTP server on the terminal 60. The HTTP server will create a java.net.ServerSocket class with a specified port. Typically, the address will be localhost or 127.0.0.1. The plug-in 110 then creates a DVBClassLoader. DVBClassLoader is a part of the MHP standard and can only load classes from a URL, e.g. from a HTTP server. The plug-in 110 passes the URL of the HTTP server that it has just created to the DVBClassLoader. Once the DVBClassLoader connects to this port a Socket (java.net.Socket) connection is created. This connection can be used for bidirectional communication. Plug-in 110 can then start the main application inside the DVBClassLoader. When an application needs to load a class, a request is sent from the DVBClassLoader to the HTTP server for the data for that class. The generated class files are then passed to the HTTP server, from where they are extracted.

In the above embodiment, a plug-in 110 converts applications into Java bytecode, which can be executed by the Java Virtual Machine. Where a different type of processing environment is used, it will be appreciated that the plug-in 110 will convert applications into code which is compatible with that environment. In the above description the plug-in 110 is an interoperable plug-in, which itself is a Java application. However, non-interoperable plug-ins may also be used, in which case the plug-in is an application compiled for the specific terminal. This type of plug-in may use a customised way of invoking the bytecode it has compiled. For example, it may have extra permissions that are not normally granted to interoperable applications, allowing it to load classes without using a local HTTP server and DvbClassLoader. This is a more efficient approach.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in the claim.

1. A method of processing an application at a terminal (60) in a digital broadcasting system, the terminal (60) supporting a virtual machine (150) which is arranged to process applications in a first code format, the method comprising the steps of:
receiving an application in a second code format; and
converting at least part of the application into the first code format.

2. A method according to claim 1 wherein the step of converting the application comprises compiling (120) the content into the first code format.

3. A method according to claim 2 further comprising executing the compiled application.

4. A method according to claim 1 further comprising storing (69) the converted code.

5. A method according to claim 1 further comprising storing (69) the received application before converting the application into the first code format.

6. A method according to claim 5 further comprising monitoring activity (114) of the virtual machine and selecting a time at which to convert the application into the first code format based on the monitored activity.

7. A method according to claim 5 further comprising interpreting (130) the received application into the first code format and monitoring usage (112) of the interpreted application, and wherein the application is compiled into the first code format based on the monitored usage.

8. A method according to claim 1 wherein the converting step comprises interpreting (130) a part of the application and compiling (120) another part of the application into the first code format.

9. A method according to claim 8 wherein the application comprises scripted actions and other content, and only the scripted actions are compiled into the first code format.

10. A method according to claim 1 wherein only selected applications received in the second code format are converted to the first code format.

11. A method according to claim 1 further comprising sending the converted application to another terminal (90, 92).

12. A method according to claim 1 wherein the virtual machine (150) is a Java virtual machine and the first code format is Java bytecode.

13. A method according to claim 1 wherein the terminal (60) is a Multimedia Home Platform (MHP) terminal and the complied content is an MHP Xlet.

14. A method according to claim 1 wherein the second code format is a legacy transmission code format.

15. A method according to claim 14 wherein the second code format is MHEG-5.

16. A control apparatus for a terminal (60) in a digital broadcasting system which is arranged to perform the method according to claim 1.

17. Software for controlling operation of a terminal (60) in the manner according to claim 1.

18. A signal, for transmission in a digital broadcasting system, which embodies the software according to claim 17.

19. A terminal (60) incorporating the control apparatus according to claim 16.
